(19) United States
(12) Patent Application Publication
(10) Pub. No.: US 2003/0220817 A1
(43) Pub. Date: Nov. 27, 2003

(54) System and method of formulating appropriate subsets of information from a patient's computer-based medical record for release to various requesting entities

(76) Inventors: Steve Larsen, Cross Plains, WI (US); Kyle Christensen, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/439,221

(22) Filed: May 15, 2003

Related U.S. Application Data
(60) Provisional application No. 60/380,714, filed on May 15, 2002.

(51) Int. Cl. G06F 17/60

(52) U.S. Cl. 705/2

(57) ABSTRACT

A method for providing appropriate release of patient information from a healthcare organization including receiving a request from an entity for a set of information associated with the patient, determining a security level associated with the entity, identifying at least one subset of information available to the entity based on the security level associated with the entity, and displaying to the entity a subset list indicating the at least one subset of information available to the entity. The method also includes receiving a subset request from the entity corresponding to the at least one subset of information selected by the entity from the subset list, retrieving a minimum amount of information corresponding to the subset request received from the entity, recording the request from the entity for the set of information, and releasing the minimum amount of information to the entity.

### CROSS-REFERENCE TO RELATED APPLICATION

This application claims priority to U.S. Provisional Application Serial No. 60/380,714, entitled “System and Method Of Formulating Appropriate Subsets Of Information From A Patient's Computer-Based Medical Record For Release To Various Requesting Entities,” filed May 15, 2002 (attorney docket no. 29794/38286), the disclosure of which is hereby expressly incorporated herein by reference.

### TECHNICAL FIELD

This patent relates to health record management, and more particularly, the present patent relates to a system for providing appropriate release of patient information to any and all requesters.

### BACKGROUND

Healthcare enterprises and integrated delivery networks are often large and diverse entities which provide many aspects of patient care and engage in many other patient related operations. From hospitals to outpatient clinics to payer organizations; from registration, scheduling, and demographics information to clinical and procedural services to billing and accounts receivable processes, a healthcare organization generates and manages a great deal of information about each patient that it serves within its network. Since this information is related to a person's medical history, it is of great importance, and since the kinds of information generated are so varied, there are a lot of entities that might have need of some or all of it.

The need for better and more secure access to this Patient Health Information. (PHI), among other things, has spurred new federal regulations for healthcare entities. The Health Insurance Portability and Accountability Act (HIPAA) sets down regulations and standards of compliance for covered entities in the healthcare industry. Many of these regulations govern privacy and the release of a patient's medical information, some of the key points of which are described below.

For example, the disclosure of PHI generally requires either consent or authorization from the patient and must be limited to the “minimum necessary” to accomplish the intended purpose of the use, disclosure, or request. Also, a covered entity must be able to provide a patient with an accounting of all disclosures of PHI to other requesters, including the following information: the date of disclosure, the person or entity to whom/which information was disclosed, a description of the nature of the disclosure, or in place of a description, a copy of the disclosure request.

Another requirement of HIPAA is that a covered entity must be able to specify which of its employees or groups of employees, based on their roles or duties, will need access to PHI. Furthermore, a covered entity must be prepared to allow patients to inspect, copy, and amend the health information used to make treatment, financial, or operational decisions about them. Yet another requirement is that a covered entity must respond to a request to inspect or copy PHI within 60 days. A request for PHI can be denied, under certain circumstances, but the covered entity is required to provide reason and explanation for the denial, as well as to review the patient's rights and how to file a complaint about the denial.

Complying with these regulations presents a significant challenge for a large and diverse Healthcare Organization (HCO), especially doing so in a timely and efficient manner. While these regulations apply to all kinds of PHI, perhaps the most problematic area of compliance for HCOs is a patient's medical record information, or chart.

The vast majority of medical records are still paper-based, and there are only a handful of organizations at this point which are entirely paperless. A paper-based medical record presents a number of problems to complying with HIPAA regulations.

For example, large numbers of medical records require a lot of physical storage space and improper or erroneous filing and multiple, geographically disparate storage sites present chart location problems and slow response times. These storage areas and the methods for physically transporting the records are not absolutely secure. Additionally, patient consent/authorization forms and requests for PHI may not be stored with the chart itself. Furthermore, changing information in a paper chart is relatively easy, but tracking or auditing those changes is very difficult, not to mention notifying appropriate providers, administrators, or the patient himself of changes to PHI. Accounting for each disclosure, when a paper medical record is used, as the HIPAA regulations require, is difficult. Additionally, establishing PHI security for a HCO's employees or groups of employees is difficult, especially given the unsecure nature of chart storage and transportation methods

Thus, in a paper-based world, any given request for information from a patient's medical record would require, for example: (1) processing the request form; (2) obtaining consent or authorization to disclose the information; (3) locating the medical record; (4) examining the nature of the request; (5) making a determination about what information from the medical record needs to be released; (6) locating and photocopying the appropriate information in the medical record itself; (7) mailing the photocopies to the requester; (8) filing the request form itself appropriately; and (9) notifying the patient or any HCO administrators of the disclosure by phone, email, and/or memo.

Such a process is complicated, involved, and prone to error, and it also generates even more paper to keep track of later. For example, when a patient requests an accounting of all the times his PHI has been disclosed, to whom, by whom, when, and for what reason (which he has a right to do free of charge once per year) each separate piece of documentation requesting information would have to be individually located and accounted for when summarizing the PHI disclosures for the patient. Not to mention the fact that the above process exposes the whole of the medical record to the HCO employee, regardless of role or security level, as well as to any other people who have physical access to the record during transport or in the photocopying area. Meanwhile, as long as the HCO employee releasing the information has possession of the chart, no one else has access to it, including caregivers at the point of service. For these, and many other reasons, HCOs are being forced to adopt paperless methods of storing and releasing PHI.

One common solution to the problems posed by paper charts is to employ a document imaging system. A good document imaging system has the capability to store, track, and allow role-based user access to scanned images. That is, an HCO using a document imaging system will scan the documents in a paper chart and create digital images of what was merely paper before. Because these medical records, or charts, are thereby stored electronically, vendors providing such services often refer to these systems as “electronic medical records.” Some of these systems also allow simultaneous tracking of the paper charts throughout the HCO until the chart system is fully digitalized, thereby helping HCOs transition to a “paperless” environment.

However, there are a number of problems that cannot be solved with a document imaging solution. First, scanned paper charts are not true Electronic Medical Records (EMR). A scanned chart is merely a picture of a document, and it does not provide real data. The information in a scanned document cannot be filtered, searched, crunched, massaged, served, recombined, or reported on as data in a data repository can. Additionally, security is inferior to that of a true EMR because granulated access cannot be attached to the sensitive data within the chart, only to the images themselves. However, any given image may be a page of a chart that contains multiple different kinds of information to which you might want to attach granulated access.

Another problem with document imaging solutions is that in practice, scanned images do not create a truly paperless environment. In fact, those solutions actually support the continuance of existing paper-based workflows because they require physical documents in order to continue scanning in new information. In the context of releasing PHI to requesters, document imaging will likely be a paper-in-paper-out scenario where medical information and requests for PHI are scanned into a digital storage mechanism and the documents needing to be released will be printed to paper by the HCO and sent to the requester.

Yet another deficiency in document imaging solutions is that decisions about what images to print still lie with an HCO employee. Even if security restricts which images an employee can access, a person must still evaluate the request for information, find it in the document imaging system, print out the relavant documents, and send them to the requester.

For an HCO adopting a true EMR, neither a paper-based solution nor a document imaging solution is adequate. Primarily, this is because there is no paper chart to be either photocopied or scanned into an imaging system. In a true EMIR, providers are collecting and recording PHI at the point of care and the EMR is filing that data directly to a data repository. Thus, in the context of releasing PHI to requesters, the HCO employee must access the EMR via a User Interface (UI) and selectively print the screens or data fields containing the information being requested. This method has all the same problems inherent in the paper-based and document imaging solutions with one other added problem: depending on how the information is structured in the EMR and how it is stored in the data repository, the available reporting tools, and the UI screens, there may not be a convenient match between what was requested and what can be printed. This would result in either the release of too much information, not enough information, or the need to “black-out” certain pieces of irrelevant or sensitive information.

There is a demonstrated need for a system that is able to formulate and release subsets of data from a true EMR based on requests for PHI from various entities while yet complying with all patient security and disclosure regulations set down in HIPAA.

### SUMMARY

The present patent overcomes the disadvantages of the prior art by providing a system that generates appropriate subsets of patient health information (PHI), provides multiple methods of releasing PHI to requesting entities, relies on extensive data structure and retrieval capabilities, and incorporates robust security features.

### BRIEF DESCRIPTION OF THE DRAWINGS

FIG. 1 is a block diagram of a general purpose data network.

FIG. 2 is a schematic diagram of an embodiment of a network computer.

FIG. 3 is a schematic diagram of several system components located in a healthcare facility.

FIG. 4 is a block diagram overview of a health care information system illustrating the interaction between an organization and a person or entity requesting information.

FIG. 5 is a graphic representation of an exemplary universal patient record.

FIG. 6 is a graphical representation of associated master files for a UPR.

FIG. 7 is a graphic representation of an exemplary data structure within the PHR.

FIG. 8 illustrates graphically a PHI Subset Engine.

FIG. 9 is a graphic representation of the manner in which security is attached to PHI Subsets.

FIG. 10 is a flowchart of a HCO employee intermediary.

FIG. 11 is a block diagram a web-based integrated patient/provider electronic medical record system.

FIG. 12 is a flowchart representation of an embodiment of direct affiliate access for information requests.

### DETAILED DESCRIPTION

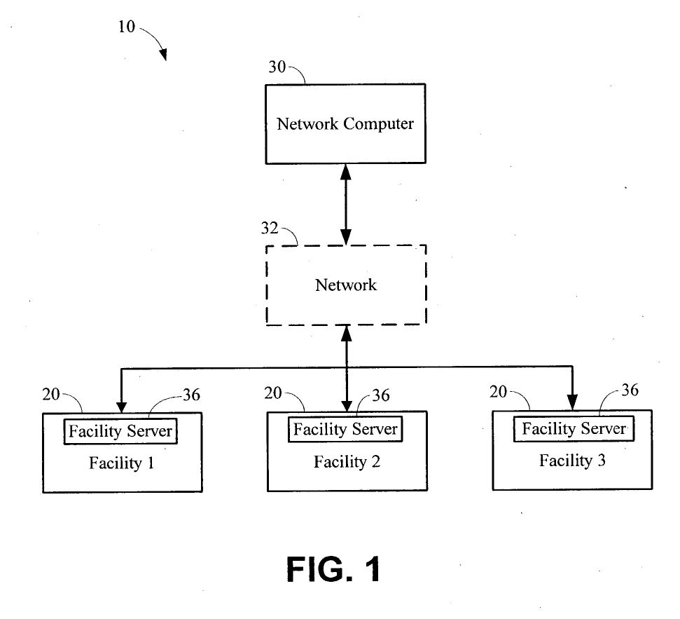

FIG. 1 illustrates an embodiment of an enterprise-wide data network 10 including a first group of healthcare facilities 20 operatively coupled to a network computer or machine 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the enterprise-wide data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

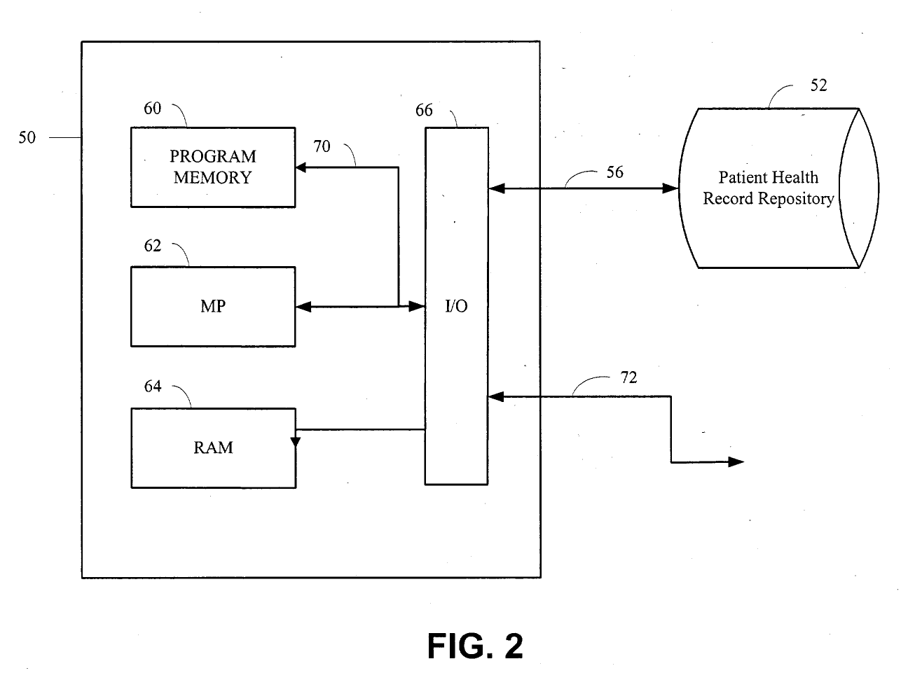

FIG. 2 is a schematic diagram of one possible embodiment of the network computer 30 shown in FIG. 1. The network computer 30 may have a controller 50 that is operatively connected to a patient health record repository 52 (such as a Universal Patient Record repository) via a link 56. The patient health record repository 52 may include one or more databases or data repositories that store patient healthcare data and related healthcare business data using one or more database management systems that run on one or more computing platforms on one or more computing devices. It should be noted that, while not shown, any additional databases or repositories may be linked to the controller 50 in a similar manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

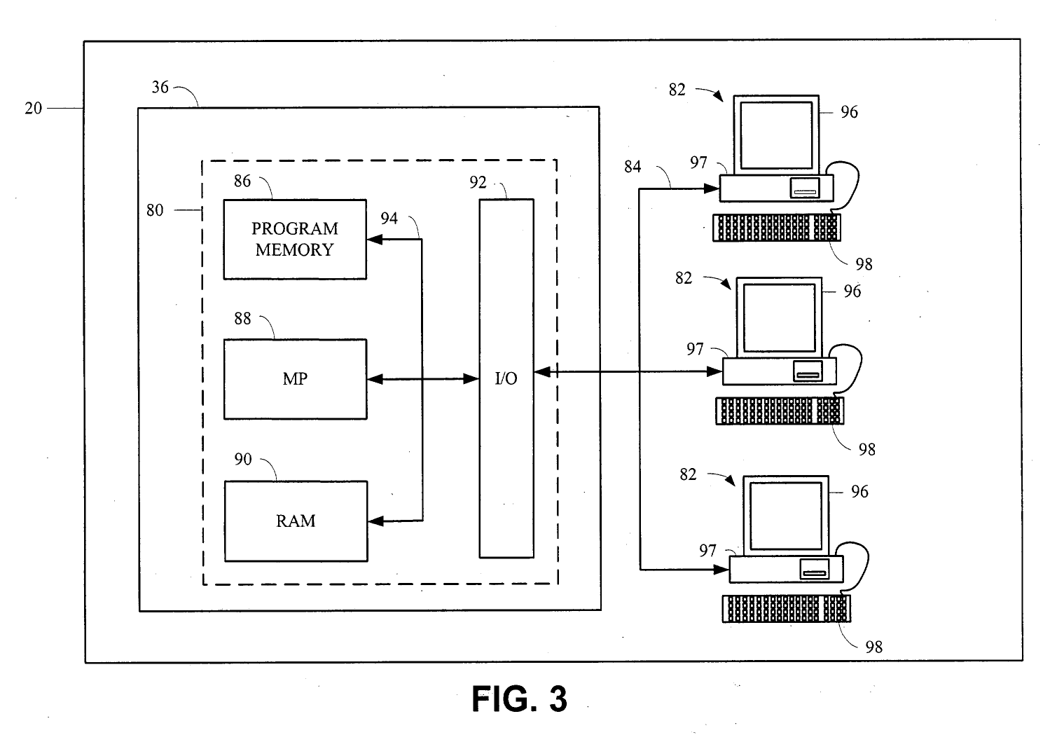

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example. All of these memories or data repositories may be referred to as machine-accessible mediums.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

### Overall Operation of the System

One manner in which an exemplary system may operate is described below in connection with a block diagram overview and a number of flow charts which represent a number of portions or routines of one or more computer programs. These computer program portions may be stored in one or more of the memories in the controllers 50 and 80, and may be written at any high level language such as C, C++, or the like, or any low-level, assembly or machine language. By storing the computer program portions therein, various portions of the memories are physically and/or structurally configured in accordance with the computer program instructions.

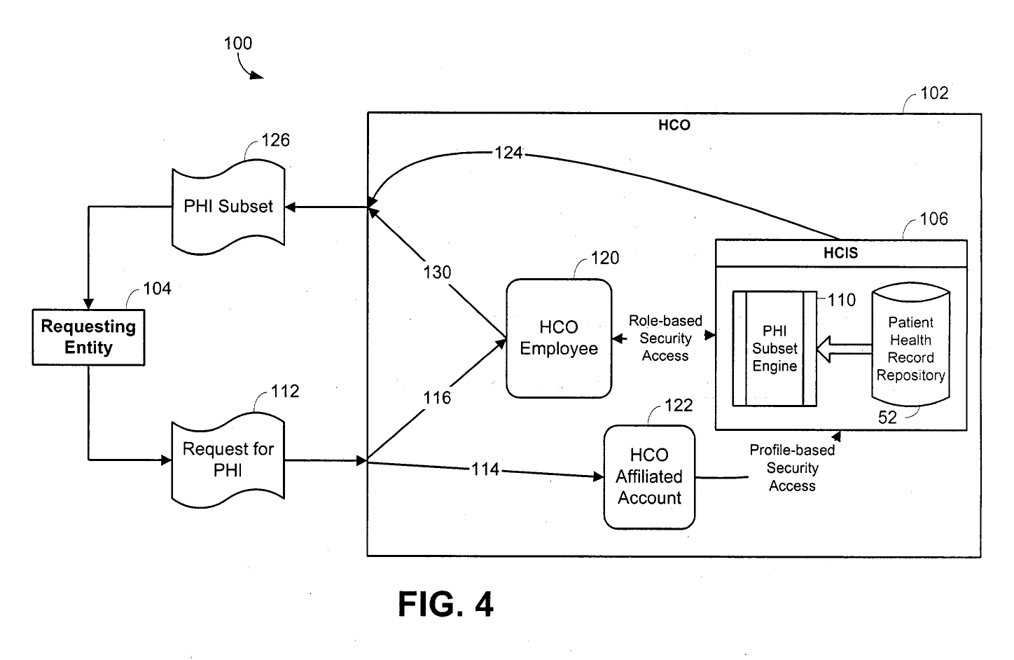

FIG. 4 is a block diagram overview of a health care information system 100 illustrating the interaction between a healthcare organization (HCO) 102 and a person or entity 104 requesting personal healthcare information (PHI). In FIG. 4, the HCO 102 contains a fully realized healthcare information system (HCIS) 106 including a Patient Health Record Repository (PHR) 52 such as Chronicles™ and a PHI Subset Engine 110 for extracting appropriate data from the PHR 52. (Chronicles is a trademark of, and the software is available from, Epic Systems Corporation of Madison, Wis.)

Referring to FIG. 4, it is envisioned that the requesting entity 104 would approach the HCO 102 with a specific request for PHI 112. The requesting entity 104 might be, for example, a patient requesting his own PHI, a law firm, a provider in another HCO, an insurance company or HMO, or another HCO's billing office, etc. Each request by the requesting entity 104 may be recorded in the PHR 52. Within the HCO 102, there are at least two primary avenues by which the request might be evaluated and either granted or denied. A first avenue 114 is by direct access to the HCO's HCIS 106 and a second avenue 116 includes being routed through a HCO employee 120 whose job it is to evaluate PHI requests from requesting entities which have not been granted direct access to the HCO's HCIS 106.

Within the HCIS 106, a PHI subset generation mechanism is provided that draws PHI directly from the PHR 52 and parcels it out in smaller pieces to which granulated security access may be attached. This security access to the PHI subsets can be applied to either the HCO employee 120 mentioned above or to people and entities given direct access (114) to the HCIS.

When an entity with direct HCIS access (114), through an affiliated account 122, logs into the system 100, the HCIS 106 may check that entity's profile to determine which PHI subsets have been authorized for that account. The HCIS 106 may then only allow access to the authorized subsets. The requesting entity 104 may select subsets as appropriate and the HCIS 106 release the information directly to the requester. For example, a HCO would allow patients access to their own PHI via the Internet using an integrated electronic health record system such as the system described in the commonly assigned U.S. Patent Application entitled “Patient Health Record Access System,” to Walter et al., Ser. No. 09/821,615, attorney docket number 29794/36547A, attached hereto as Appendix A.

A patient with an account setup within the HCO 102 may log in and see not only their medical information but other entities requesting that information and download or print out any of the PHI subsets available to them through the HCO 102. While access to this information may be granulated and security based, in the case of a patient, each person would likely be granted access to view, print and edit the information in his or her own chart.

When an entity without direct access to the HCO's HCIS 106 requests information about a patient, the request 124 may be routed through the HCO employee 120 via route 116. This may be referred to as intermediary access. In the system of FIG. 4, the HCO employee 120 has a defined role in the organization to which appropriate HCIS security levels and access are assigned. This employee 120 evaluates the nature of the PHI request 124 and identifies which PHI subsets are appropriate for fulfilling the requests (i.e. the minimum necessary amount of information). Based on his role, a list of PHI subsets is available to the HCO employee 120, and he may select the PHI subset 126 that is appropriate. The HCO employee 120 may then release the information to the requester (intermediary release 130), providing the HCO 102 has obtained patient consent or authorization as specified in the HIPAA regulations. The system 100 of FIG. 4 may check a flag within the patient's record to determine whether patient's consent and/or authorization has been obtained. If it has not, then no information may be printed or released.

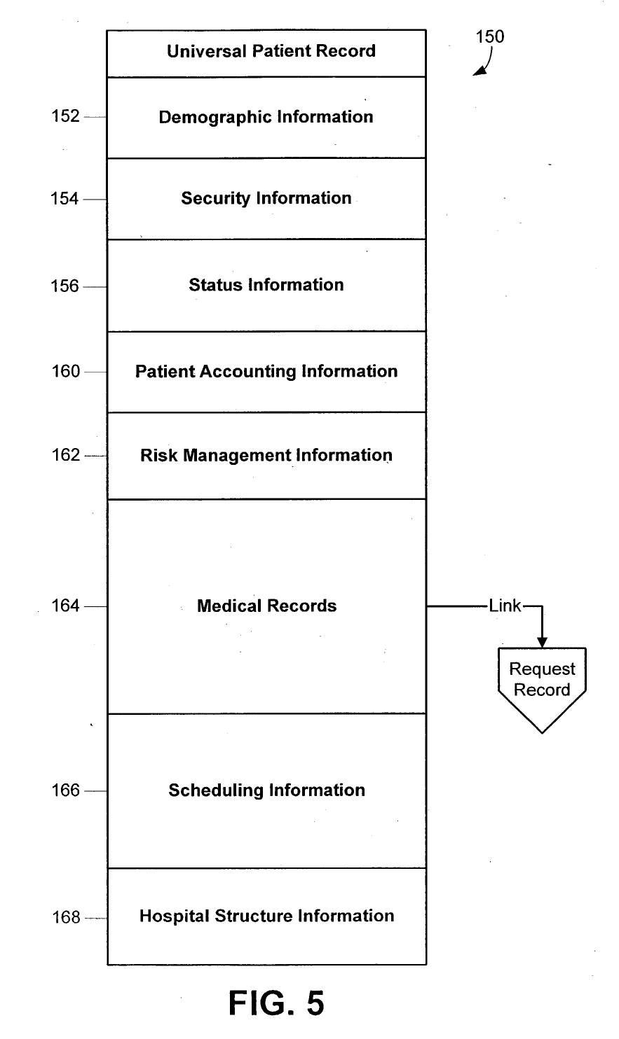

FIG. 5 is a graphic representation of a universal patient record 150 usable within the health care information system 100 in accordance with an embodiment of the invention. The patient health record repository 52 of the HCIS may utilize, for example, a universal patient record (UPR), shown in FIG. 5, and as described in the commonly assigned U.S. Patent Application entitled “System and Method for Integration of Health Care Records,” to Dvorak, et al., Ser. No. 10/007,066, attorney docket number 29794/36697A, incorporated herein by reference. The UPR 150 includes information regarding health care delivery, and information regarding health care delivery management for a particular patient. The information in the UPR 150 may include patient demographic information 152 that includes the patent's address, employer, emergency and religious contacts; security information 154 that includes service areas, PCP, and restricted status flag; status information 156 that includes Inpatient and Ambulatory flags, registration status, and past Inpatient IDs; patient accounting information 160 that includes guarantors, claims and links to accounts; risk management information 162 that includes coverages, payor, plan, referral information, and contracts; medical records 164 that includes both Inpatient and Ambulatory encounters, medications, allergies, immunizations, medical and surgical History, family and social risk factors, current and historical problem list, test results, care giver log, documentation, orders and care plans; scheduling information 166 that includes times, dates, locations, providers, types of appointment, reasons for visiting, multiple notes, and arrival status for past and future appointments in both inpatient and outpatient facilities; and hospital structure information 168 that includes hospital unit, patient room number, patient bed number, services, and treatment teams. Information regarding health care delivery may include medical records 164. Information regarding health care delivery management may include patient demographic information 152, security information 154, status information 156, patient accounting information 160, risk management information 162, scheduling information 166 and hospital structure information 168. The UPR 150 may be one of many UPRs within the health care system 100, where each UPR maintains demographic, security, status, accounting, risk management, medical record, scheduling and hospital structure information for corresponding patients. The data stored in each UPR may be formatted text/data, links to formatted text/data, or selections from a list of available data.

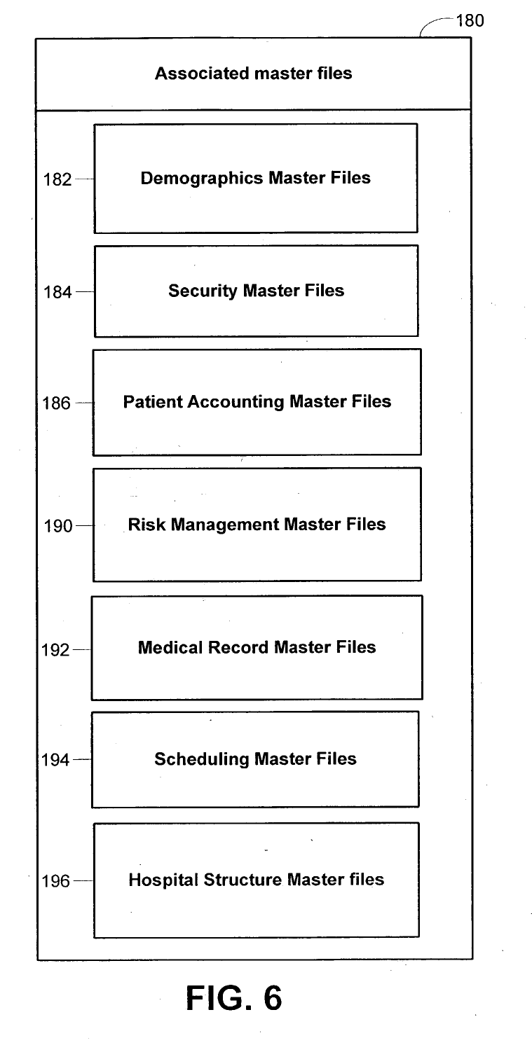

FIG. 6 is an exemplary graphical representation of associated master files 180 stored in the central data repository used for the UPR 150 of FIG. 5. The master files 180 may include demographics master files 182 which include non-patient-specific information on demographics topics, security master files 184 which include non-patient-specific information on security topics, and patient accounting master files 186 which include non-patient-specific information on accounting topics. The master files 180 may further include risk management master files 190 which include non-patient-specific information on risk management topics, medical record master files 192 which include non-patient-specific information on medical record topics, scheduling master files 194 which include non-patient-specific information on scheduling topics, and hospital structure master files 196 which include non-patient-specific information on hospital structure. The one or more UPRs of the health care system include links to records/files in corresponding master files, allowing patient-specific information to be stored in a manner that supports integrated features.

Alternatively, the patient health record repository 52 may comprise multiple databases residing on one or more storage media, interfacing with a single health care application or multiple health care applications comprising the HCIS 106, as would be appreciated by one skilled in the art. In addition, the HCIS 106 and WHD may utilize a seamless user interface, such as for example, the seamless user interface described in the commonly assigned U.S. Patent Application entitled “System and Method for a Seamless User Interface For an Integrated Electronic Health Care Information System,” to Brummel, et al., Ser. No. 10/007,620, attorney docket number 29794/37022A, incorporated herein by reference.

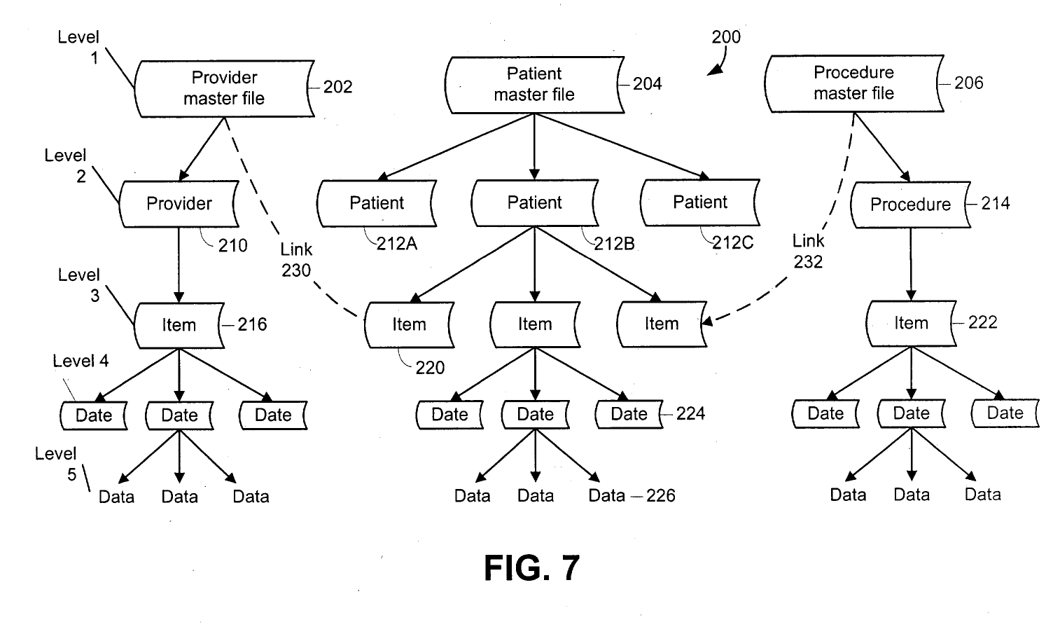

FIG. 7 is an exemplary graphic representation 200 of the way data might be structured within the PHR 150. The data structure of the embodiment 200 shown in FIG. 7 has, essentially, 5 levels at which to access information on a data tree.

The first level is the master file level. This level represents a collection of like entities within which records can be created and about which data can be collected. For example, FIG. 7 depicts three such master files: a Provider master file 202, a Patient master file 204, and a Procedure master file 206. However, it is to be understood that there could be any number of master files, depending on the implementation of the HCIS 106.

The second level is the record level. This level represents an individual entity within a given master file. For example, within the Provider master file 202, a record 210 represents an individual physician, nurse, assistant, etc. Within the Patient master file 204, a record 212A-C corresponds to a patient. And within the Procedure master file 206, a record 214 corresponds to an individual procedure performed on the patient during his visit.

The third Level is the item level. This level represents an individual piece of information which is collected for a given record. For example, within a Provider's record 210, it may be desirable to record his specialty 216. Within the Patient's record 212B, it may be desirable to record his primary care provider 220. Within the Procedure record, it may be desirable to record its billing status 222.

The fourth Level is the contact level. This level represents the individual date on which a user records a value for an item. For example, within the patient's record 212B, it might be desirable to record the blood pressure every time the patient comes in to see his physician, and each time, the physician (or other appropriate party) would record the reading in the same item (224).

The fifth Level is the data item level. This level represents multiple values for a given item, recorded on a given date. For example, in the patient's record 212B it may be desirable to record all the insurance coverages he currently has whenever he visits his physician (226).

The embodiment of FIG. 7 allows for links 230 and 232 between the master files at the Item level. For example, if a user wanted to record which providers treated a patient when he came in, the user might utilize the link 230 between the Provider master file 202 and the Treatment Team item in the patient's record 220. If the user wanted to record which procedures a patient was seen for, the user might utilize the link 232 with the Procedures master file 206. This linking ensures cohesion between master files 202-206 and correct, timely data.

The branching structure of the data allows for any number of different subsets or combinations of data upon retrieval, depending on the parameters specified. For example, a user might access a patient record and return all the branches beneath it, thereby providing a complete history of a patient's record within the PHR 150. Or, by specifying the appropriate Item and Date, a user might return the primary care provider for every patient on a certain date. Or, a user might simply return a single item for a single patient record on a certain date. As previously described, the data retrieved may be released via print or electronic formats.

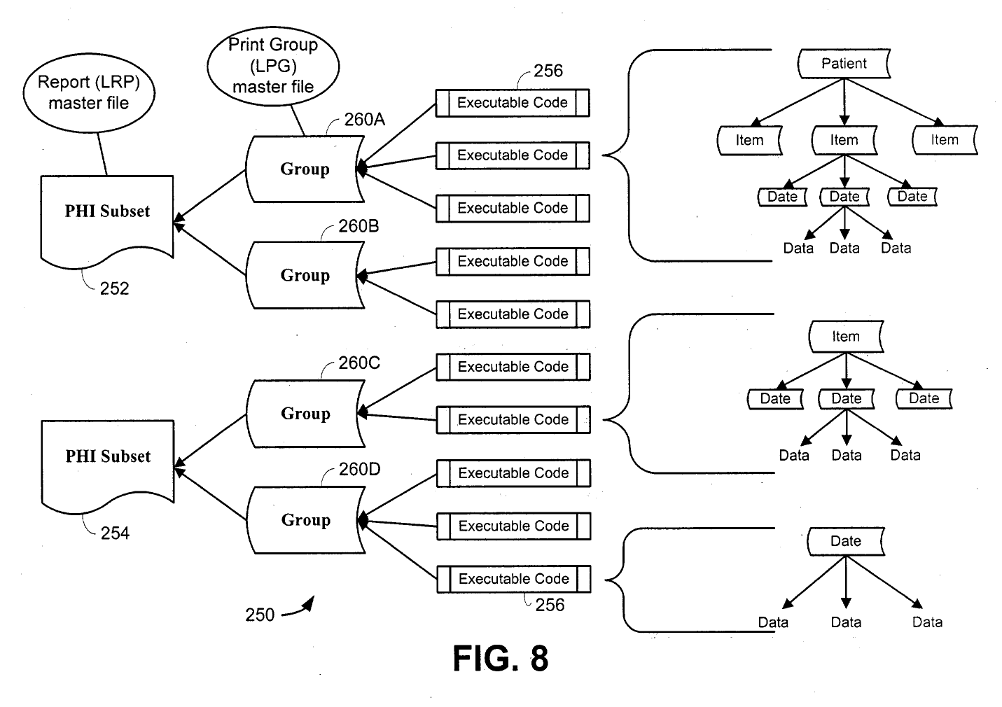

FIG. 8 illustrates graphically an exemplary PHI Subset Engine 250. Each PHI Subset 252 and 254 is ultimately a combination of different pieces of data stored within the data structures 200 shown in FIG. 7. For any given set of data, beginning at any of the five levels described in FIG. 7, executable code 256 is written to access the data tree and return specific data according to the parameters of the executable code 256. This code may be written with specific intent to access certain levels and return predictable kinds of data. For example, executable code might be written to return a patient's Blood Pressure on a certain date, his Treatment Team for a hospital stay, his Registration and Demographic information, his allergies, or his medications.

Once written, these pieces of executable code 256 can then be listed in various Groups 260A-D. A group, in turn, becomes the amalgamation of the pieces of executable code it contains. For example, a user might create a group that lists two pieces of executable code and returns a list of a patient's Allergies and Medications respectively. Or, the user might create a group that returns the Allergies, Medications, and Demographics information.

Once the Groups 260A-D have been created, they can then be attached to the PHI Subsets 252, 254 themselves. The PHI Subsets 252, 254, then, are composed of Groups 260A-D which are in turn composed of pieces of executable code 256. Thus, the HCO 102 can create an infinite number of customized PHI Subsets, to either use internally or release to requesters.

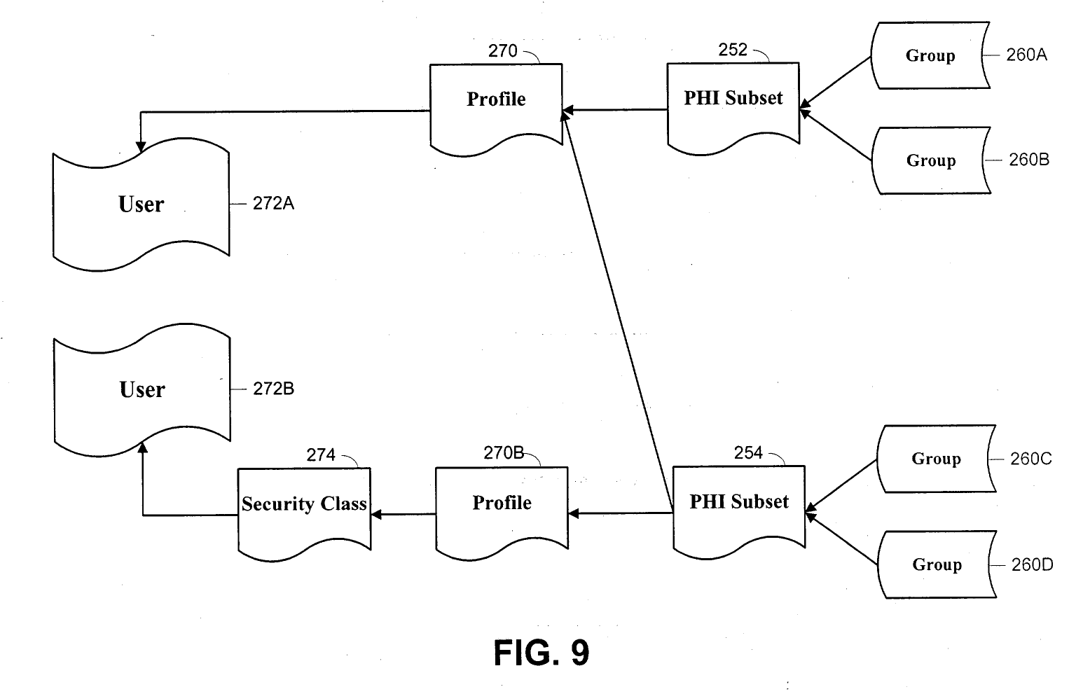

FIG. 9 is a graphic representation of an exemplary manner in which security is attached to PHI Subsets 252, 254. As an overview, security may be attached to sensitive patient information at the finest levels of data storage, including role based security for employees and access level based for affiliates. Referring to FIG. 9, one or more subsets 252, 254, including one or more Groups 260A-D, may be attached to a Profile 270A-B. A profile or profiles may then be attached directly to a user, or indirectly to a user 272A-B via a Security Class 274, wherein the security class 274 is a predefined role or collection of security access points to which many different system users might belong. When the User 272A-B logs into the HCIS 106, either the HCO employee 120 or a user with an affiliated account, their user record may be checked for the authorized Profiles 270A-B, thereby notifying the system of which PHI Subsets 252, 254 that user has access to.

This security configuration has the crucial benefit of allowing an organization to attach security to even the smallest piece of data. For example, there might be an Item 220 in a patient's master file record 204 indicating a status of the patient, e.g. as having a particular ailment or being a VIP. Executable code 256 may be written to return this value and that code may be listed in a Group 260A-D. That group, in turn, being a sensitive group, will be added to a select few PHI Subsets 252, 254. A HCO, then, knowing which Profiles need access to such information, would only attach that profile to particular users. Thus, a HCO might create two PHI Subsets which are nearly identical in-the information they contain, except for the Group containing the status information. Only users with the appropriate security (that is, the right profile) would ever see that information. And, if that user is a HCO employee, he could never release that data to a requester if he himself had no access to it.

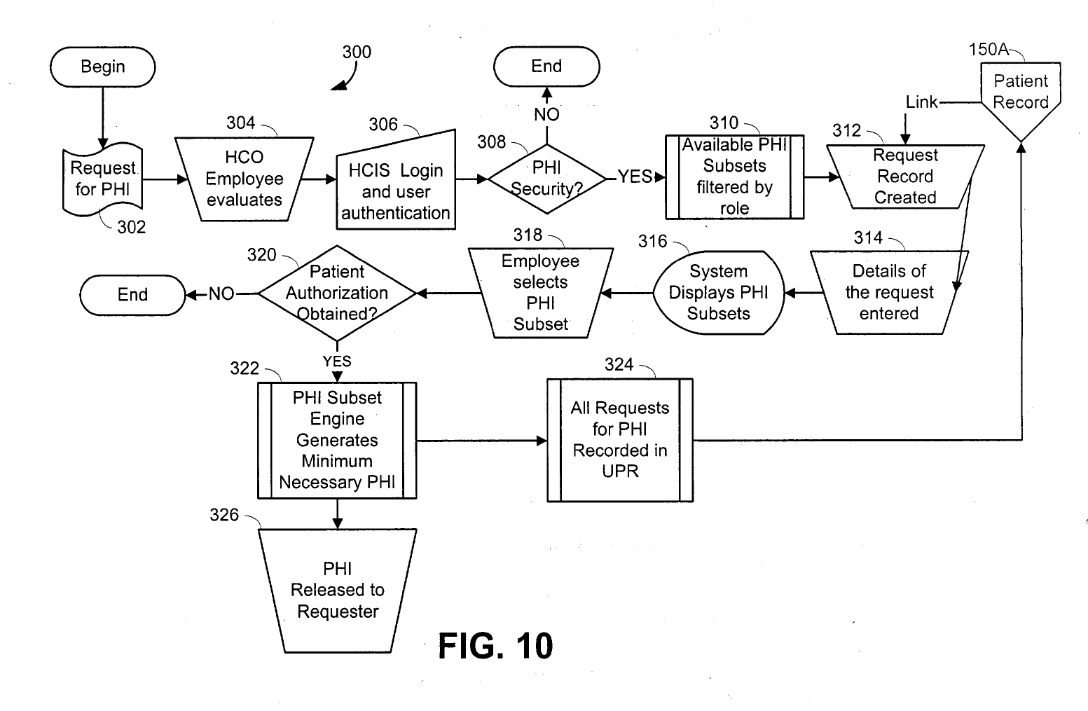

FIG. 10 is a flowchart 300 depicting an embodiment of a typical release of information via the HCO employee 120. A HCO receives a request for PHI (block 302) via one of a number of conventional methods e.g. phone, letter, email, etc. It is envisioned that a HCO would have one or more employees devoted to processing these requests.

When a request for PHI is received, the HCO employee 120 would do some initial evaluation of the request and its nature (block 304). If it is a request that can be granted by law, the user may be required to log in to the HCIS in order to fulfill the request (block 306).

At log in, the user's security may be checked for a profile (block 308). According to this profile, that is, according to the level of security attached to an employee based on his role, the PHI Subsets available to him may be defined, even before he can select them (block 310).

In order to fulfill the request, a user may be prompted to create a new request by entering some basic information such as the patient's name and who the requesting party is. The HCIS 106 may then create a Request record (block 312) in the Release of Information master file which is linked to the patient's record 150A.

The HCO user may then fill out a number of data fields to collect the specific information about the request currently being made (block 314). For example, he might record information such as: status, release type, priority, date needed by the requester, what information was requested, the requesting entity's address and phone, and whether the request has been authorized.

The user may then access a print option in the interface to display the PHI Subsets available to him (block 316) and select one (block 318). The system might then check at a block 320 to see whether an authorization had been obtained from the patient before generating the PHI Subset (block 322) in a printable report format and recording the request in the patient's record (block 324). The printed report format could then be sent to the requesting entity (block 326).

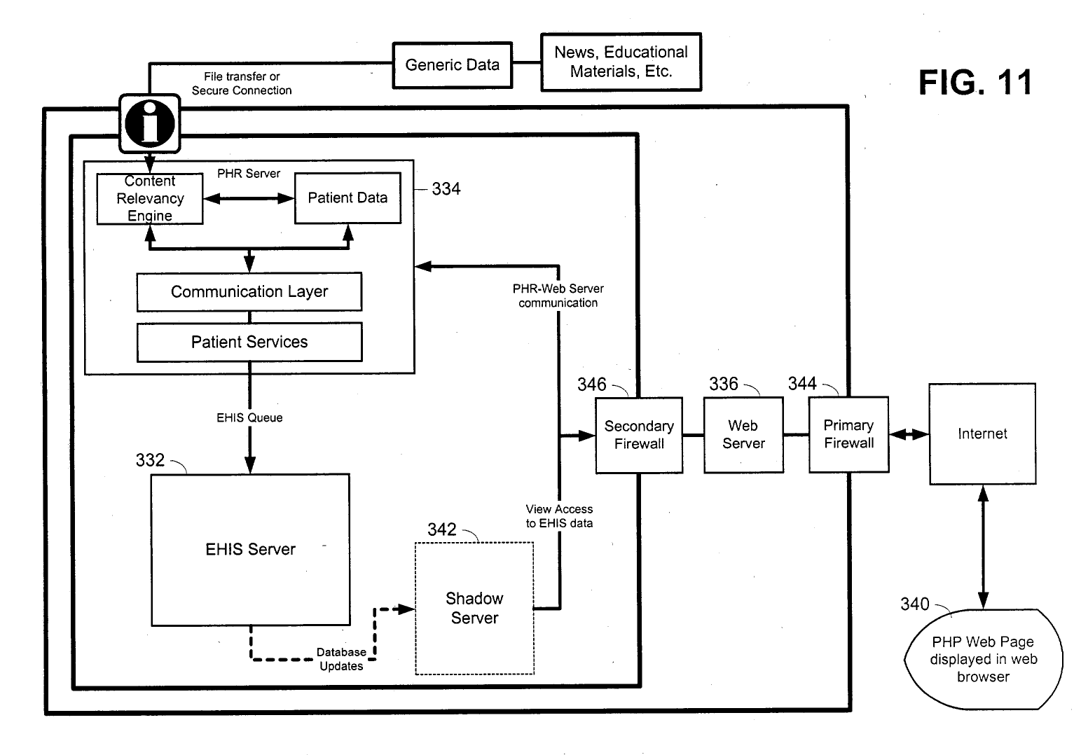

The patient medical record (PMR) block diagram illustrated in FIG. 11 is an embodiment of a web-based integrated patient/provider electronic medical record system 330. The system 330 includes an EHIS data server 332 to store provider-created patient health data and the routines for managing access and use of said data, a PHR server 334 to store data entered by the patient and the routines for managing access and use of the data, and a web server 336 that stores routines for displaying the PHP web page 340 and for managing online communication between a user logged into his PHP web page and the PHR/EHIS servers 332, 334.

FIG. 11 also illustrates a shadow server 342 that maintains a copy of the EHIS server 332 and is used to make the EHIS server 332 highly available for EHIS system operations. In the embodiment of FIG. 11, the EHIS and PHR servers 332, 334 reside between a highly secure dual firewall configuration. In this configuration the web server 336 is protected by a primary firewall 344 and EHIS 332, shadow 342 and PHR 334 servers are protected by a secondary firewall 346.

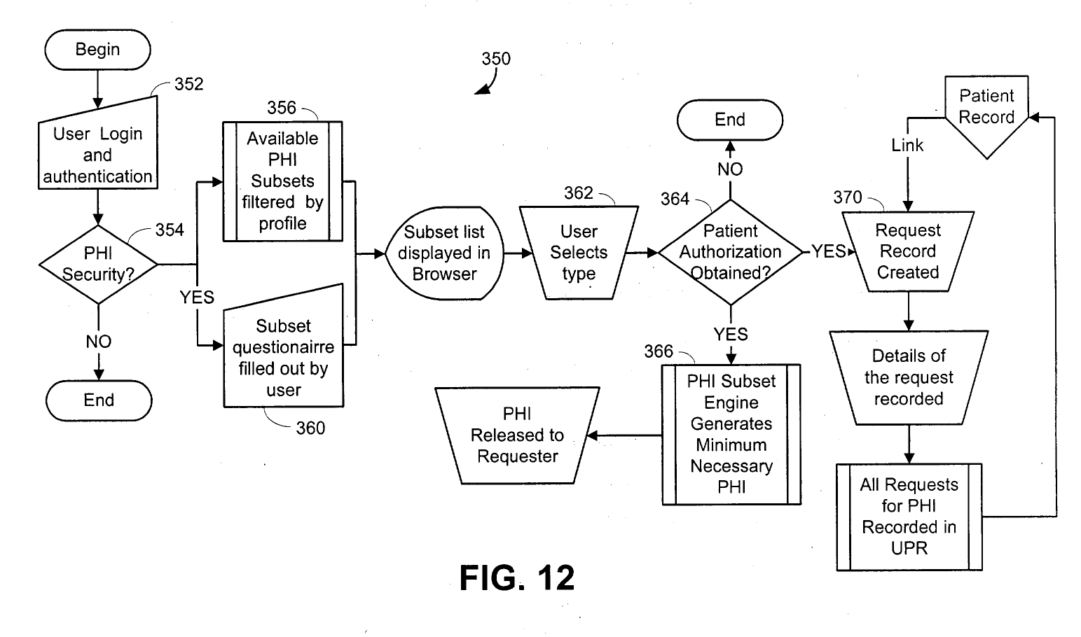

FIG. 12 is a flowchart 350 depicting an embodiment of a typical release of information process via an affiliated account's direct access. The embodiment of FIG. 12 is part of a larger system that is described in the U.S. patent application Ser. No. 09/821,615. While the embodiment of FIG. 12 provides for access by the patient himself, it is to be understood that direct access could be similarly provided to affiliated entities, that is, entities with which a HCO has a PHI sharing agreement. For example, a HCO might enter into an agreement with an affiliated payer organization such as an HMO or an insurance company.

Initially, an entity with an account would log into the HCIS (block 352). At log in time, the user's security access level may be authenticated (block 354) and the appropriate PHI Subsets may be identified based on the profile assigned to a user's record (block 356). Two things might then happen, according to a HCO's individual implementation of the HCIS. A list of all available subsets might be simply presented to the user or some decision support might be implemented. For example, the user might fill out a questionnaire containing questions about the nature of the request, it's intended use, the information required, etc. (block 360). Based on this questionnaire, the HCIS might recommend one or more of the available subsets. The user may then select an available subset (block 362).

At this point, the system might check whether patient authorization has been obtained (block 364) before generating the PHI subset in a report format (block 366) and creating a Request record (block 370) in the Release of Information master file for the request.

Although the technique for providing the appropriate release of patient information described herein, is preferably implemented in software, it may be implemented in hardware, firmware, etc., and may be implemented by any other processor associated with a healthcare enterprise. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other machine accessible storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method for providing appropriate release of patient information from a healthcare organization comprising:
receiving a request at the healthcare organization from an entity for a set of information associated with the patient;
determining a security level associated with the entity;
identifying at least one subset of information available to the entity based on the security level associated with the entity;
displaying to the entity a subset list indicating the at least one subset of information available to the entity;
receiving a subset request from the entity corresponding to the at least one subset of information selected by the entity from the subset list;
retrieving a minimum amount of information corresponding to the subset request received from the entity;
recording the request from the entity for the set of information; and
releasing the minimum amount of information to the entity.

2. The method of claim 1, comprising determining if the patient has authorized a release of the minimum amount of information before releasing the minimum amount of information to the entity.

3. The method of claim 1, wherein retrieving the minimum amount of information comprises retrieving a group that corresponds to the at least one subset and has an executable routine that is adapted to retrieve a specific piece of data from a universal patient record associated with the patient.

4. The method of claim 1, comprising linking a group to the at least one subset, wherein the group includes a specific piece of information corresponding to the patient.

5. The method of claim 1, wherein receiving the request at the healthcare organization from the entity comprises receiving the request via the Internet.

6. The method of claim 1, wherein recording the request from the entity for the set of information comprises recording the request in a universal patient record associated with the patient.

7. The method of claim 1, wherein retrieving the minimum amount of information corresponding to the subset request received from the entity comprises retrieving the minimum amount of information from a universal patient record associated with the patient.

8. The method of claim 1, wherein determining the security level associated with the entity comprises identifying a profile previously assigned to the entity.

9. The method of claim 8, comprising associating the at least one subset with the profile.

10. The method of claim 1, wherein determining the security level associated with the entity comprises associating a security class with the entity, wherein the security class includes a plurality of security access points.

11. A method for providing appropriate release of patient information from a healthcare organization comprising:
receiving a request at the healthcare organization from an entity for a set of information associated with the patient;
evaluating the request for the set of information by a user associated with the healthcare organization;
determining if the request for the set of information should be granted by the user;
determining a security level associated with the user;
identifying at least one subset of information available to the user based on the security level associated with the user;
displaying to the user a subset list indicating the at least one subset of information available to the user;
receiving a subset request from the user corresponding to the at least one subset of information selected by the user from the subset list;
retrieving from the universal patient record a minimum amount of information corresponding to the subset request received from the user;
determining if the patient has authorized a release of the minimum amount of information before releasing the minimum amount of information to the entity;
recording the request from the user for the set of information in a universal patient record associated with the patient; and
releasing the minimum amount of information to the entity.

12. The method of claim 11, wherein retrieving from the universal patient record the minimum amount of information comprises retrieving a group that corresponds to the at least one subset and has an executable routine that is adapted to retrieve a specific piece of data from a universal patient record associated with the patient.

13. The method of claim 11, comprising linking a group to the at least one subset, wherein the group includes a specific piece of information corresponding to the patient.

14. The method of claim 11, wherein receiving the request at the healthcare organization from the entity comprises receiving the request via the Internet.

15. The method of claim 11, wherein determining the security level associated with the user comprises identifying a profile previously assigned to the user.

16. The method of claim 15, comprising associating the at least one subset with the profile.

17. The method of claim 11, wherein determining the security level associated with the user comprises associating a security class with the user, wherein the security class includes a plurality of security access points.

18. A system for providing appropriate release of patient information comprising:
means for receiving a request from an entity for a set of information associated with the patient;
means for determining a security level associated with the entity;
means for identifying at least one subset of information available to the entity based on the security level associated with the entity;
means for displaying to the entity a subset list indicating the at least one subset of information available to the entity;
means for receiving a subset request from the entity corresponding to the at least one subset of information selected by the entity from the subset list;
means for retrieving a minimum amount of information corresponding to the subset request received from the entity;
means for recording the request from the entity for the set of information; and
releasing the minimum amount of information to the entity.

19. The system of claim 18, comprising means for determining if the patient has authorized a release of the minimum amount of information before releasing the minimum amount of information to the entity.

20. The system of claim 18, wherein the means for retrieving the minimum amount of information comprises means for retrieving a group that corresponds to the at least one subset and has an executable routine that is adapted to retrieve a specific piece of data from a universal patient record associated with the patient.

21. The system of claim 18, comprising means for linking a group to the at least one subset, wherein the group includes a specific piece of information corresponding to the patient.

22. The system of claim 18, wherein the means for recording the request from the entity for the set of information comprises means for recording the request in a universal patient record associated with the patient, and wherein the means for retrieving the minimum amount of information corresponding to the subset request received from the entity comprises means for retrieving the minimum amount of information from the universal patient record.

23. The system of claim 18, wherein the means for determining the security level associated with the entity comprises means for identifying a profile previously assigned to the entity.

24. The system of claim 23, comprising means for associating the at least one subset with the profile.

25. A system for providing appropriate release of patient information from a healthcare organization comprising:
means for receiving a request at the healthcare organization from an entity for a set of information associated with the patient;
means for evaluating the request for the set of information by a user associated with the healthcare organization;
means for determining if the request for the set of information should be granted by the user;
means for determining a security level associated with the user;
means for identifying at least one subset of information available to the user based on the security level associated with the user;
means for displaying to the user a subset list indicating the at least one subset of information available to the user;
means for receiving a subset request from the user, corresponding to the at least one subset of information selected by the user from the subset list;
means for retrieving from the universal patient record a minimum amount of information corresponding to the subset request received from the user;
means for determining if the patient has authorized a release of the minimum amount of information before releasing the minimum amount of information to the entity;
means for recording the request from the user for the set of information in a universal patient record associated with the patient; and
means for releasing the minimum amount of information to the entity.

26. The system of claim 25, wherein the means for retrieving from the universal patient record the minimum amount of information comprises means for retrieving a group that corresponds to the at least one subset and has an executable routine that is adapted to retrieve a specific piece of data from a universal patient record associated with the patient.

27. The system of claim 25, comprising means for linking a group to the at least one subset, wherein the group includes a specific piece of information corresponding to the patient.

28. The system of claim 25, wherein the means for determining the security level associated with the user comprises means for identifying a profile previously assigned to the user.

29. The system of claim 28, comprising means for associating the at least one subset with the profile.

30. The system of claim 25, wherein the means for determining the security level associated with the user comprises means for associating a security class with the user, wherein the security class includes a plurality of security access points.

31. An article comprising a machine-accessible medium having stored thereon instructions that, when executed by a machine, cause the machine to:
accept a request at a healthcare organization from an entity for a set of information associated with a patient;
determine a security level associated with the entity;
identify at least one subset of information available to the entity based on the security level associated with the entity;
display to the entity a subset list indicating the at least one subset of information available to the entity;
accept a subset request from the entity corresponding to the at least one subset of information selected by the entity from the subset list;
retrieve from a universal patient record associated with the patient a minimum amount of information corresponding to the subset request received from the entity;
determine if the patient has authorized a release of the minimum amount of information before releasing the minimum amount of information to the entity
record the request from the entity for the set of information in the universal patient record; and
release the minimum amount of information to the entity.

32. The article of claim 31, having further instructions that, when executed by the machine, cause the machine to retrieve a group that corresponds to the at least one subset and has an executable routine that is adapted to retrieve a specific piece of data from the universal patient record.

33. The article of claim 31, having further instructions that, when executed by the machine, cause the machine to link a group to the at least one subset, wherein the group includes a specific piece of information corresponding to the patient.

34. The article of claim 31, having further instructions that, when executed by the machine, cause the machine to identify a profile previously assigned to the entity.

35. The article of claim 34, having further instructions that, when executed by the machine, cause the machine to associate the at least one subset with the profile.

36. The article of claim 31, having further instructions that, when executed by the machine, cause the machine to associate a security class with the entity, wherein the security class includes a plurality of security access points.
